(19) United States
(12) Patent Application Publication
(10) Pub. No.: US 2014/0132611 A1
(43) Pub. Date: May 15, 2014

(54) SYSTEM AND METHOD FOR DATA TRANSMISSION

(71) Applicant: NVIDIA CORPORATION, Santa Clara, CA (US)

(72) Inventors: SHIFU CHEN, Shenzhen (CN); YANBING SHAO, Shenzhen (CN); JIHUA YU, Shenzhen (CN); WENZHI LIU, Beijing (CN); WENBO JI, Shenzhen (CN)

(73) Assignee: NVIDIA CORPORATION, Santa Clara, CA (US)

(21) Appl. No.: 13/754,069

(22) Filed: Jan. 30, 2013

(30) Foreign Application Priority Data
Nov. 9, 2012 (CN) 201210448813.8

(51) Int. Cl. G06F 13/16

(52) U.S. Cl. CPC G06F 13/1663
USPC 345/502

(57) ABSTRACT

The present invention discloses a system and a method for data transmission. The system includes: a plurality of graphics processing units; a global shared memory for storing data transmitted among the plurality of graphics processing units; an arbitration circuit module, which is coupled to each of the plurality of graphics processing units and the global shared memory and configured to arbitrate an access request to the global shared memory from respective graphics processing units to avoid an access conflict among the plurality of graphics processing units. The system and the method for data transmission provided by the present invention enable respective GPUs in the system to transmit data through the global shared memory rather than a PCIE interface, thus saving data transmission bandwidth significantly and further improving a computing speed.

### CROSS-REFERENCE TO RELATED APPLICATIONS

This application claims priority to Chinese Patent Application No. 201210448813.8, filed on Nov. 9, 2012, which is hereby incorporated by reference in its entirety.

### BACKGROUND OF THE INVENTION

### Field of the Invention

The present invention relates generally to graphics processing, and in particular, to method and system for data transmission.

Graphics card, which is one of the most basic components of a personal computer, takes on the task of outputting graphics for being displayed. Graphics processing unit (GPU), the core of a graphics card, substantially decides performance of a graphics card. Initially, GPU is mainly used for rendering graphics and its interior is mainly constituted by a fixed number of “pipelines” that are divided into pixel pipelines and vertex pipelines. A new generation of DX 10 graphics card 8800GTX was officially released by NVIDIA in December 2006, and it replaces pixel pipelines and vertex pipelines with stream processors (SPs). The performance of GPU in certain computation, such as a floating point operation, parallel computing, etc., is actually much better than that of CPU, therefore the application of a GPU is no longer limited to graphics processing but begins to enter high-performance computing (HPC) in the present. In June 2007, NVIDIA introduced a Compute Unified Device Architecture (CUDA), which uses a unified processing architecture to lower programming difficulties and introduces an on-chip shared memory to improve efficiency.

Currently, a PCIE interface is typically used for communication among different GPUs in graphics processing or general purpose computing on a multi-GPU system. However, communication bandwidth between a GPU and a CPU must be occupied when using a PCIE interface and the bandwidth of the PCIE interface is limited, so the transmission rate is not ideal and the high computing performance of a GPU cannot be fully utilized.

Therefore, there is a need for a system and a method for data transmission to solve the above problem.

### SUMMARY OF THE INVENTION

A series of concepts in abbreviated forms are introduced in the summary of the invention, which will be further explained in detail in the part of detailed description. This part of the present invention does not mean trying to define key features and essential technical features of the technical solution claimed for protection; even not mean trying to determine a protection scope of the technical solution claimed for protection.

In order to solve the above problem, the present invention provides a system for data transmission including: a plurality of GPUs; a global shared memory for storing data transmitted among the plurality of GPUs; an arbitration circuit module, which is coupled to each of the plurality of GPUs and the global shared memory and configured to arbitrate an access request to the global shared memory from respective GPUs to avoid an access conflict among the plurality of CPUs.

In an alternative embodiment of the present invention, the system further includes a plurality of local device memory, each of which is coupled to each of the plurality of GPUs respectively.

In an alternative embodiment of the present invention, each of the plurality of GPUs further includes a frame buffer configured to buffer data transmitted on each of the plurality of GPUs, and a volume of the frame buffer is not larger than a volume of the global shared memory.

In an alternative embodiment of the present invention, the volume of the frame buffer is configurable so that: the data are sent to the global shared memory via the frame buffer in batches if a size of the data is larger than the volume of the global shared memory; and the data are sent to the global shared memory via the frame buffer all at once if the size of the data is not larger than the volume of the global shared memory.

In an alternative embodiment of the present invention, the arbitration circuit module is configured so that: when the access request is sent to the arbitration circuit module by one GPU of the plurality of GPUs, the arbitration circuit module allows the one GPU of the plurality of GPUs to access the global shared memory if the global shared memory is in an idle state; and the arbitration circuit module does not allow the one GPU of the plurality of GPUs to access the global shared memory if the global shared memory is in an occupied state.

In an alternative embodiment of the present invention, each of the plurality of GPUs includes a PCIE interface for data transmission among the plurality of GPUs when there is the access conflict.

In an alternative embodiment of the present invention, the global shared memory further includes channels coupled with respective GPUs respectively, and the data are transmitted directly between the global shared memory and respective GPUs over the channels.

In an alternative embodiment of the present invention, the arbitration circuit module is configured to be able to communicate with respective GPUs, and the data are transmitted between the global shared memory and respective GPUs via the arbitration circuit module.

In an alternative embodiment of the present invention, the arbitration circuit module is an individual module, a part of the global shared memory or a part of respective GPUs.

In an alternative embodiment of the present invention, the arbitration circuit module is consisted of any of an FPGA, a single chip microcomputer and a logic gate circuit.

In another aspect of the invention, a method for data transmission is also provided. The method includes: transmitting data from one GPU of a plurality of GPUs to another GPU of the plurality of GPUs through a global shared memory; during the transmitting, arbitrating an access request to the global shared memory from respective GPUs of the plurality of GPUs by an arbitration circuit module.

In an alternative embodiment of the present invention, the arbitrating includes: when the access request is sent to the arbitration circuit module by one GPU of the plurality of GPUs, allowing the one GPU of the plurality of GPUs to access the global shared memory by the arbitration circuit module if the global shared memory is in an idle state; and not allowing the one GPU of the plurality of GPUs to access the global shared memory by the arbitration circuit module if the global shared memory is in an occupied state.

In an alternative embodiment of the present invention, the transmitting data includes: writing the data into the global shared memory by the one GPU of the plurality of GPUs; and reading the data from the global shared memory by the another GPU of the plurality of GPUs.

In an alternative embodiment of the present invention, the transmitting data further includes reading the data from a local device memory corresponding to the one GPU of the plurality of GPUs by the one GPU of the plurality of GPUs before writing the data into the global shared memory by the one GPU of the plurality of GPUs.

In an alternative embodiment of the present invention, the transmitting data further includes writing the read data into a local device memory corresponding to the another GPU of the plurality of GPUs by the another GPU of the plurality of GPUs after reading the data from the global shared memory by the another GPU of the plurality of GPUs.

In an alternative embodiment of the present invention, each of the plurality of GPUs further includes a frame buffer configured to buffer data transmitted on each of the plurality of GPUs, and a volume of the frame buffer is not larger than a volume of the global shared memory.

In an alternative embodiment of the present invention, the volume of the frame buffer is configurable so that: the data are sent to the global shared memory via the frame buffer in batches if a size of the data is larger than the volume of the global shared memory; and the data are sent to the global shared memory via the frame buffer all at once if the size of the data is not larger than the volume of the global shared memory.

In an alternative embodiment of the present invention, the global shared memory further includes channels coupled with respective GPUs respectively, and the data are transmitted directly between the global shared memory and respective GPUs over the channels.

In an alternative embodiment of the present invention, the arbitration circuit module is configured to be able to communicate with respective GPUs, and the data are transmitted between the global shared memory and respective GPUs via the arbitration circuit module.

In another aspect of the invention, a graphics card is also provided. The graphics card includes a system for data transmission, the system for data transmission including: a plurality of GPUs; a global shared memory for storing data transmitted among the plurality of GPUs; an arbitration circuit module, which is coupled to each of the plurality of GPUs and the global shared memory, and configured to arbitrate an access request to the global shared memory from respective GPUs to avoid an access conflict among the plurality of GPUs.

The system and the method for data transmission provided by the present invention enable the GPUs in the system to transmit data through the global shared memory rather than a PCIE interface, thus avoiding sharing bandwidth with a CPU bus, and therefore the transmission speed is faster.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a schematic block diagram of a system for data transmission, according to a preferable embodiment of the present invention;

FIG. 2 illustrates a flow chart of arbitrating an access request of a GPU by an arbitration circuit module, according to a preferable embodiment of the present invention;

FIG. 3 illustrates a schematic block diagram of a system for data transmission, according to another embodiment of the present invention; and

FIG. 4 illustrates a flow chart of a method for data transmission, according to a preferable embodiment of the present invention.

### DETAILED DESCRIPTION

A plenty of specific details are presented so as to provide more thoroughly understanding of the present invention in the description below. However, the present invention may be implemented without one or more of these details, as is obvious to those skilled in the art. In other examples, some of the technical features known in the art are not described so as to avoid confusions with the present invention.

Detailed structures will be presented in the following description for more thoroughly appreciation of the invention. Obviously, the implementation of the invention is not limited to the special details well-known by those skilled in the art. Preferred embodiments are described as following; however, the invention could also comprise other ways of implementations.

The present invention sets forth a system and a method for data transmission. Data transmission among different GPUs in a system without through a PCIE interface may be realized by using the method. The number of GPUs is not limited, but only a first GPU and a second GPU are used as examples for illustrating how data to be transmitted among different GPUs in a system in embodiments of the present invention.

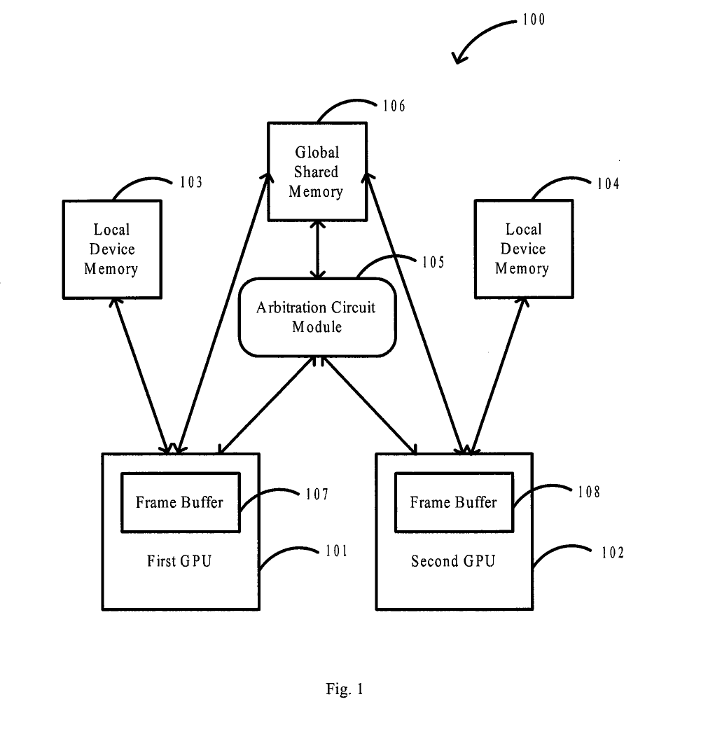

FIG. 1 illustrates a schematic block diagram of a system for data transmission 100 according to a preferable embodiment of the present invention. As shown in FIG. 1, the system for data transmission 100 includes a first GPU 101, a second GPU 102, an arbitration circuit module 105 and a global shared memory 106. Therein, the first GPU 101 and the second GPU 102 may be equivalent GPUs.

According to a preferable embodiment of the present invention, the system for data transmission 100 may further include a first local device memory 103 corresponding to the first GPU 101 and a second local device memory 104 corresponding to the second GPU 102. The first local device memory 103 is coupled to the first GPU 101. The second local device memory 104 is coupled to the second GPU 102. Persons of ordinary skill in the art will understand that the above local device memory may be one or more memory particles. The local device memory may be used to store data that have been processed or to be processed by the GPU.

According to a preferable embodiment of the present invention, the first GPU 101 may further include a first frame buffer 107, and the second GPU 102 may further include a second frame buffer 108. Each frame buffer is used to buffer data transmitted on its corresponding GPU and the volume of the frame buffer is not larger than the volume of the global shared memory.

For example, when data are to be transferred from the first local device memory 103 corresponding to the first GPU 101 to the global shared memory 106, the data are transferred to the first frame buffer 107 in the first GPU 101 firstly and then are transferred from the first frame buffer 107 to the global shared memory 106. In contrast, when data are to be transferred from the global shared memory 106 to the first local device memory 103 corresponding to the first GPU 101, the data are transferred to the first frame buffer 107 in the first GPU 101 firstly and then are transferred from the first frame buffer 107 to the first local device memory 103. For the second frame buffer 108, situation is same as described above.

Persons of ordinary skill in the art will understand that data may be transferred from the first GPU 101 to the global shared memory 106 directly without through the first local device memory 103. Data may be transferred from the global shared memory 106 to the first GPU 101 in order to involve in computations of the first GPU 101directly.

Depending on the size of the data to be transmitted and the volume of the global shared memory, the volume of each frame buffer is configurable so that: the data are sent to the global shared memory 106 via the frame buffer in batches if the size of the data is larger than the volume of the global shared memory; and the data are sent to the global shared memory 106 via the frame buffer all at once if the size of the data is not larger than the volume of the global shared memory. For example, when the data are transferred from the first local device memory 103 to the second local device memory 104, if the size of the data is larger than the volume of the global shared memory 106, the following steps may be performed. The first frame buffer 107 is configured to be equal to the volume of the global shared memory 106 and the second frame buffer 108 is configured to be equal to the volume of the first frame buffer 107. The data are divided into several parts, the size of each of which is equal to or smaller than the volume of the first frame buffer 107. Then the first part of the data is transferred to the first frame buffer 107 firstly and then is written into the global shared memory 106. Then this part of the data is transferred from the global shared memory 106 to the second frame buffer 108 and then is written into the second local device memory 104. Then the next part of the data is transferred from the first local device memory 103 to the second local device memory 104 in accordance with the above sequence. The rest parts of the data may be transferred in the same manner until the data transfer has been completed. When the data are transferred from the first local device memory 103 to the second local device memory 104, if the size of the data is not larger than the volume of the global shared memory 106, the following steps may be performed. The first frame buffer 107 is configured to be equal to the size of the data and the second frame buffer 108 is configured to be equal to the volume of the first frame buffer 107. The entire data may be transferred from the first local device memory 103 to the second local device memory 104 all at once. When the data are transferred from the second local device memory 104 to the first local device memory 103, the second frame buffer 108 can be configured firstly and the first frame buffer 107 can be subsequently configured, which is same as described above.

According to a preferable embodiment of the present invention, the arbitration circuit module 105 is coupled with the first GPU 101 and the second GPU 102 respectively. The arbitration circuit module arbitrates the access requests to the global shared memory 106 from the first GPU 101 and the second GPU 102 to avoid access conflicts between the two different GPUs. In particular, the arbitration circuit module 105 may be configured so that: when an access request is sent to the arbitration circuit module 105 by one GPU of the plurality of GPUs, the arbitration circuit module 105 allows the one GPU of the plurality of GPUs to access the global shared memory 106 if the global shared memory 106 is in an idle state; and the arbitration circuit module 105 does not allow the one GPU of the plurality of GPUs to access the global shared memory 106 if the global shared memory 106 is in an occupied state. In particular, that the global shared memory 106 is in an idle refers to none of the CPUs are accessing the global shared memory 106, and that the global shared memory 106 is in an occupied state refers to at least one of the GPUs is accessing the global shared memory 106.

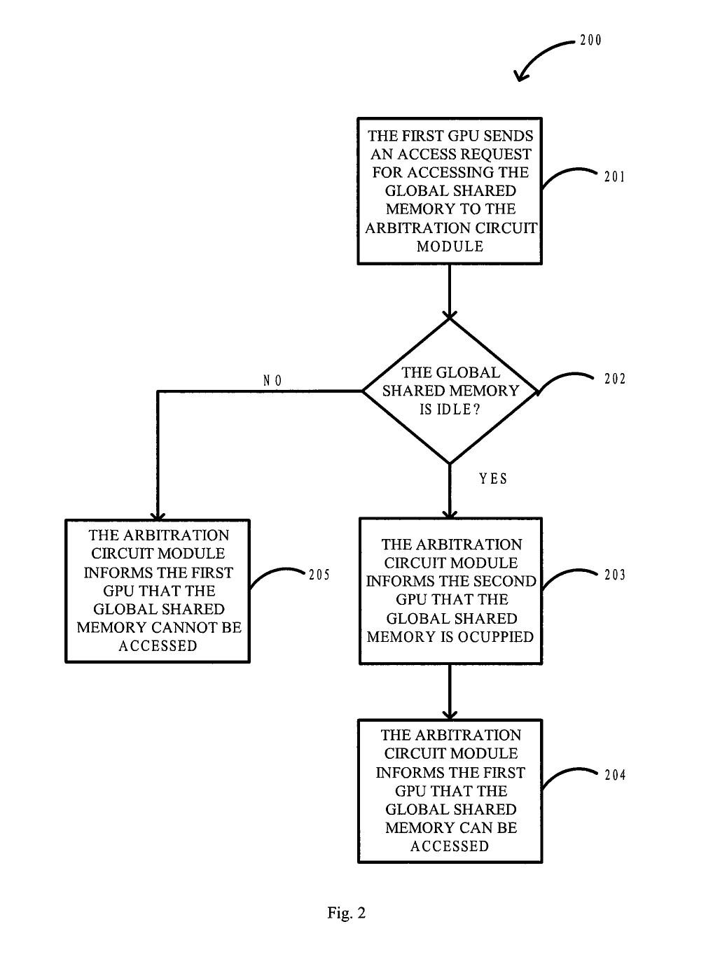

The arbitration process 200 of the arbitration circuit module 105 is specifically shown in FIG. 2 and is described below with reference to FIG. 1 and FIG. 2. At step 201, the first GPU 101 sends an access request for accessing the global shared memory 106 to the arbitration circuit module 105 at first. At step 202, it is judged whether or not the global shared memory 106 is in an idle state, and if the global shared memory 106 is in an idle state, then the arbitration process 200 proceeds to step 203, where the arbitration circuit module 105 sends a signal to the second GPU 102 for indicating that the global shared memory 106 is being used. Then the arbitration process 200 proceeds to step 204, where the arbitration circuit module 105 sends a signal to the first GPU 101 for indicating that the global shared memory 106 can be used. If at step 202, the global shared memory 106 is in an occupied state, then the arbitration process 200 proceeds to step 205, where the arbitration circuit module 105 sends a signal to the first GPU 101 for indicating that the global shared memory 106 can't be accessed. At this time the first GPU 101 might periodically detect the state of the arbitration circuit module 105. If the arbitration circuit module 105 shows that the global shared memory 106 is in an idle state during this time, then the first GPU 101 begins to access the global shared memory 106, or else the first GPU 101 would transmit the data through other ways (for example, a PCIE interface on the first GPU 101). Preferably, if the first GPU 101 and the second GPU 102 access the global shared memory 106 at the same time, then which one is accessible to the global shared memory 106 is decided depending on a priority mechanism. The priority mechanism may include identifying which one of the first GPU 101 and the second GPU 102 has accessed the global shared memory 106 most recently and defining that the priority level of the other GPU is higher. The GPU with the higher priority level may access the global shared memory 106 at first. When the second GPU 102 sends an access request to the arbitration circuit module 105, the situation is same as described above.

According to an alternative embodiment of the present invention, the access to the global shared memory 106 may include at least one of writing data and reading data. For example, when data are transferred from the first GPU 101 to the second GPU 102, the access to the global shared memory 106 by the first GPU 101 is writing data and the access to the global shared memory 106 by the second GPU 102 is reading data.

According to an alternative embodiment of the present invention, the global shared memory 106 may further include channels coupled with respective GPUs respectively, and the data are transmitted directly between the global shared memory 106 and respective GPUs over the channels. As shown in FIG. 1, the global shared memory 106 is a multi-channel memory with two channels coupled with the first GPU 101 and the second GPU 102 respectively and a channel coupled to the arbitration circuit module 105. Data are transmitted between the global shared memory 106 and the first frame buffer 107 of the first GPU 101 or the second frame buffer 108 of the second GPU 102 through the two channels and the arbitration circuit module 105 is only used for arbitration management of the accesses of the first GPU 101 and the second GPU 102.

According to a preferable embodiment of the present invention, the arbitration circuit module 105 may be an individual module. The arbitration circuit module 105 may also be a part of the global shared memory 106 or a part of respective GPUs. In other words, the arbitration circuit module 105 may be integrated into respective GPUs or the global shared memory 106. The arbitration circuit module 105 implemented as an individual module is beneficial for management and may be replaced in time when there is an error. Integrating the arbitration circuit module 105 into respective GPUs or the global shared memory 106 needs to design or manufacture the GPU or the global shared memory separately.

According to an preferable embodiment of the present invention, the arbitration circuit module 105 may be any circuit that is able to realize the above arbitration mechanism, including but not limited to any consisted of an FPGA, a single chip microcomputer and a logic gate circuit, etc.

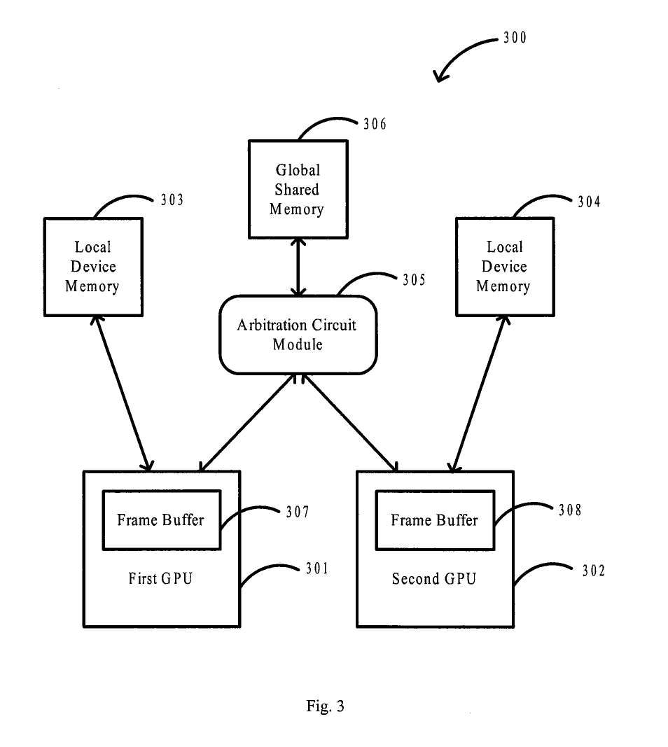

FIG. 3 is a schematic block diagram of a system for data transmission 300 according to another embodiment of the present invention. According to the embodiment, the arbitration circuit module 305 is configured to be able to communicate with respective GPUs, and the data are transmitted between the global shared memory 306 and respective GPUs via the arbitration circuit module 305. The global shared memory 306 is only coupled with the arbitration circuit module and may be implemented as any type of memory. As shown in FIG. 3, the data are transmitted between the global shared memory 306 and the first frame buffer 307 of the first GPU 301 or the second frame buffer 308 of the second GPU 302 via the arbitration circuit module 305. The arbitration circuit module 305 may be configured to be used for data transmission between the global shared memory 306 and respective GPUs except of arbitration management of the accesses of the first GPU 301 and the second GPU 302. Using the configuration of the system 300, a traditional memory, for example a SRAM, a SDRAM, etc. rather than a multi-channel global shared memory may be used.

According to another aspect of the present invention, a method for data transmission is provided. The method includes: transmitting data from one GPU of a plurality of GPUs to another GPU of the plurality of GPUs through a global shared memory; during the transmitting, arbitrating an access request to the global shared memory from respective GPUs of the plurality of GPUs by an arbitration circuit module.

According to an embodiment of the present invention, the arbitrating may include: when the access request is sent to the arbitration circuit module by one GPU of the plurality of GPUs, allowing the one GPU of the plurality of GPUs to access the global shared memory by the arbitration circuit module if the global shared memory is in an idle state; and not allowing the one GPU of the plurality of GPUs to access the global shared memory by the arbitration circuit module if the global shared memory is in an occupied state.

According to an embodiment of the present invention, the transmitting data may include: writing the data into the global shared memory by the one GPU of the plurality of GPUs; and reading the data from the global shared memory by the another GPU of the plurality of GPUs.

Alternatively, the transmitting data may also include reading the data from a local device memory corresponding to the one GPU of the plurality of GPUs by the one GPU of the plurality of GPUs before writing the data into the global shared memory by the one GPU of the plurality of GPUs.

Alternatively, the transmitting data may also include writing the read data into a local device memory corresponding to the another GPU of the plurality of GPUs by the another GPU of the plurality of GPUs after reading the data from the global shared memory by the another GPU of the plurality of GPUs.

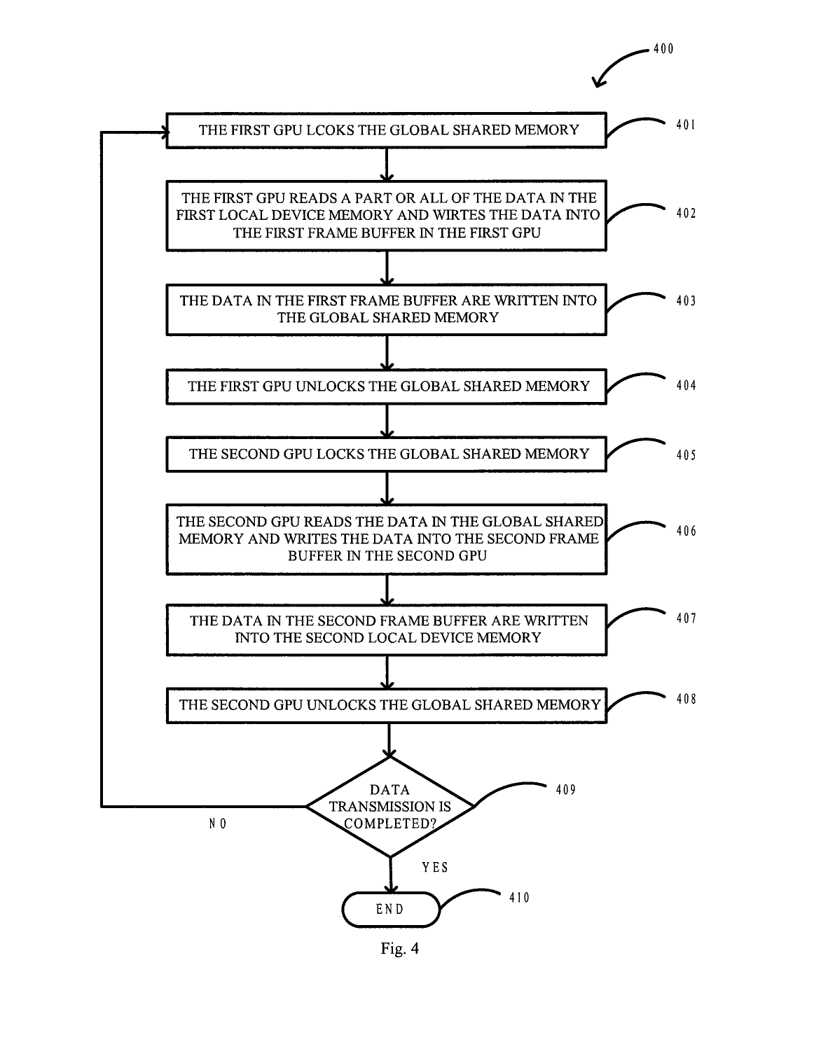

FIG. 4 illustrates a flow chart of a method for data transmission 400 according to a preferable embodiment of the present invention. In particular, at step 401, the first GPU 101 locks the global shared memory 106 through the arbitration circuit module 105. The locking process is the above arbitration process. The first GPU 101 sends an access request to the arbitration circuit module 105, and the arbitration circuit module 105 disables the access of the second GPU 102 and authorizes the first GPU 101. Then at step 402, a part or all of the data in the first local device memory 103 are read by the first GPU 101 depending on the size of the data and the volume of the global shared memory 106 and written into the first frame buffer 107 in the first GPU 101. At step 403, the data in the first frame buffer 107 are written into the global shared memory 106. At step 404, the first GPU 101 unlocks the global shared memory 106 through the arbitration circuit module 105 which terminates the access right of the first GPU 101. At step 405, the second GPU 102 locks the global shared memory 106 through the arbitration circuit module 105. The locking process is the same as that of the first GPU 101. The second GPU 102 has the right to access the global shared memory 106 at this time. At step 406, the data in the global shared memory 106 are read by the second GPU 102 and written into the second frame buffer 108 in the second GPU 102. At step 407, the data in the second frame buffer 108 are written into the second local device memory 104 corresponding to the second GPU 102. Then at step 408, the second GPU 102 unlocks the global shared memory 106 through the arbitration circuit module 105 which terminates the access right of the second GPU 102. At step 409, whether the data transmission has been completed is judged. If the data transmission has been completed, then the method 400 proceeds to step 410 where the method 400 is ended; if the data transmission has not been completed, then the method 400 returns to step 401 and repeats the above steps of the method 400 until all of the data have been transferred from the first local device memory 103 corresponding to the first GPU 101 to the second local device memory 104 corresponding to the second GPU 102.

As described in the related description of embodiments of the system for data transmission, the local device memory does not necessarily involve in the above data transmission process.

The GPU, the global shared memory and the arbitration circuit module involved in the above method have been described in the description about embodiments of the system for data transmission. For brevity, a detailed description thereof is omitted. Those skilled in the art can understand that specific structure and operation mode thereof with reference to FIG. 1 to FIG. 4 in combination with the above description.

In yet another aspect of the present invention, a graphics card including the above system for data transmission is also provided. For brevity, a detailed description thereof is omitted. Those skilled in the art can understand that specific structure and operation mode of the graphics card with reference to FIG. 1 to FIG. 4 in combination with the above description.

Data transmission among different GPUs may be implemented within the above graphic card.

The system and the method for data transmission provided by the present invention enable respective GPUs in the system to transmit data through the global shared memory rather than a PCIE interface, thus avoiding sharing bandwidth with a CPU bus, and therefore the transmission speed is faster.

The present invention has been described through the above-mentioned embodiments. However, it will be understand that the above-mentioned embodiments are for the purpose of demonstration and description and not for the purpose of limiting the present to the scope of the described embodiments. Moreover, those skilled in the art could appreciated that the present invention is not limited to the above mentioned embodiments and that various modifications and adaptations in accordance of the teaching of the present invention may be made within the scope and spirit of the present invention. The protection scope of the present invention is further defined by the following claims and equivalent scope thereof.

1. A system for data transmission including:
a plurality of graphics processing units;
a global shared memory for storing data transmitted among the plurality of graphics processing units;
an arbitration circuit module, which is coupled to each of the plurality of graphics processing units and the global shared memory and configured to arbitrate an access request to the global shared memory from respective graphics processing units to avoid an access conflict among the plurality of graphics processing units.

2. The system of claim 1, wherein the system further includes a plurality of local device memory, each of which is coupled to each of the plurality of graphics processing units respectively.

3. The system of claim 1, wherein each of the plurality of graphics processing units further includes a frame buffer configured to buffer data transmitted on each of the plurality of graphics processing units, and a volume of the frame buffer is not larger than a volume of the global shared memory.

4. The system of claim 3, wherein the volume of the frame buffer is configurable so that:
the data are sent to the global shared memory via the frame buffer in batches if a size of the data is larger than the volume of the global shared memory; and
the data are sent to the global shared memory via the frame buffer all at once if the size of the data is not larger than the volume of the global shared memory.

5. The system of claim 1, wherein the arbitration circuit module is configured so that:
when the access request is sent to the arbitration circuit module by one graphics processing unit of the plurality of graphics processing units,
the arbitration circuit module allows the one graphics processing unit of the plurality of graphics processing units to access the global shared memory if the global shared memory is in an idle state; and
the arbitration circuit module does not allow the one graphics processing unit of the plurality of graphics processing units to access the global shared memory if the global shared memory is in an occupied state.

6. The system of claim 1, wherein each of the plurality of graphics processing units includes a PCIE interface for data transmission among the plurality of graphics processing units when there is the access conflict.

7. The system of claim 1, wherein the global shared memory further includes channels coupled with respective graphics processing units respectively, and the data are transmitted directly between the global shared memory and respective graphics processing units over the channels.

8. The system of claim 1, wherein the arbitration circuit module is configured to be able to communicate with respective graphics processing units, and the data are transmitted between the global shared memory and respective graphics processing units via the arbitration circuit module.

9. The system of claim 1, wherein the arbitration circuit module is an individual module, a part of the global shared memory or a part of respective graphics processing units.

10. The system of claim 1, wherein the arbitration circuit module is consisted of any of an FPGA, a single chip microcomputer and a logic gate circuit.

11. A method for data transmission including:
transmitting data from one graphics processing unit of a plurality of graphics processing units to another graphics processing unit of the plurality of graphics processing units through a global shared memory;
during the transmitting, arbitrating an access request to the global shared memory from respective graphics processing units of the plurality of graphics processing units by an arbitration circuit module.

12. The method of claim 11, wherein the arbitrating includes:
when the access request is sent to the arbitration circuit module by one graphics processing unit of the plurality of graphics processing units,
allowing the one graphics processing unit of the plurality of graphics processing units to access the global shared memory by the arbitration circuit module if the global shared memory is in an idle state; and
not allowing the one graphics processing unit of the plurality of graphics processing units to access the global shared memory by the arbitration circuit module if the global shared memory is in an occupied state.

13. The method of claim 11, wherein the transmitting data includes:
writing the data into the global shared memory by the one graphics processing unit of the plurality of graphics processing units; and
reading the data from the global shared memory by the another graphics processing unit of the plurality of graphics processing units.

14. The method of claim 13, wherein the transmitting data further includes reading the data from a local device memory corresponding to the one graphics processing unit of the plurality of graphics processing units by the one graphics processing unit of the plurality of graphics processing units before writing the data into the global shared memory by the one graphics processing unit of the plurality of graphics processing units.

15. The method of claim 13, wherein the transmitting data further includes writing the read data into a local device memory corresponding to the another graphics processing unit of the plurality of graphics processing units by the another graphics processing unit of the plurality of graphics processing units after reading the data from the global shared memory by the another graphics processing unit of the plurality of graphics processing units.

16. The method of claim 11, wherein each of the plurality of graphics processing units further includes a frame buffer configured to buffer data transmitted on each of the plurality of graphics processing units, and a volume of the frame buffer is not larger than a volume of the global shared memory.

17. The method of claim 16, wherein the volume of the frame buffer is configurable so that:
the data are sent to the global shared memory via the frame buffer in batches if a size of the data is larger than the volume of the global shared memory; and
the data are sent to the global shared memory via the frame buffer all at once if the size of the data is not larger than the volume of the global shared memory.

18. The method of claim 11, wherein the global shared memory further includes channels coupled with respective graphics processing units respectively, and the data are transmitted directly between the global shared memory and respective graphics processing units over the channels.

19. The method of claim 11, wherein the arbitration circuit module is configured to be able to communicate with respective graphics processing units, and the data are transmitted between the global shared memory and respective graphics processing units via the arbitration circuit module.

20. A graphics card including a system for data transmission, the system for data transmission including:
a plurality of graphics processing units;
a global shared memory for storing data transmitted among the plurality of graphics processing units;
an arbitration circuit module, which is coupled to each of the plurality of graphics processing units and the global shared memory, and configured to arbitrate an access request to the global shared memory from respective graphics processing units to avoid an access conflict among the plurality of graphics processing units.
